(19) United States
(12) Patent Application Publication
(10) Pub. No.: US 2026/0089692 A1
(43) Pub. Date: Mar. 26, 2026

(54) CROSS-LINK RESOURCE TRIGGERING FOR XR SERVICES ROUND-TRIP DELAY MINIMIZATION

(71) Applicant: Apple Inc., Cupertino, CA (US)

(72) Inventors: Ping-Heng Kuo, London (GB); Naveen Kumar Palle Venkata, San Diego, CA (US); Peng Cheng, Beijing (CN); Ralf Rossbach, Munich (DE); Alexander Sirotkin, Hod Hasharon (IL); Sethuraman Gurumoorthy, San Ramon, CA (US); Fangli Xu, Beijing (CN)

(21) Appl. No.: 19/109,173

(22) PCT Filed: Sep. 18, 2023
(86) PCT No.: PCT/US2023/032979

§ 371 Date: Mar. 6, 2025

Related U.S. Application Data
(60) Provisional application No. 63/409,239, filed on Sep. 23, 2022.

(51) Int. Cl. H04W 72/044; H04W 16/28; H04W 28/02; H04W 72/11; H04W 72/12; H04W 72/231

(52) U.S. Cl. CPC H04W 72/044; H04W 16/28; H04W 28/0278; H04W 72/11; H04W 72/12; H04W 72/231

(57) ABSTRACT

Techniques, described herein, include solutions for reducing round-trip time (RTT) in extended reality (XR) applications. The techniques described herein allow for reduction of RTT while also considering user equipment (UE) energy efficiency. The network (e.g., a base station) may pre-configure the UE for resource allocation in response to a triggering event. During operation, the UE may detect the triggering event based on a data packet in an uplink (UL) data transmission. The base station may receive the UL data transmission and detect the triggering event based on the same data packet. Based on the pre-configuration, the base station and the UE can activate a resource (e.g., a downlink (DL) semi-persistent scheduling (SPS) resource) and the UE can receive a corresponding DL data transmission without the need for additional signaling.

### REFERENCE TO RELATED APPLICATIONS

This Application claims the benefit of U.S. Provisional Application No 63/409,239, filed on Sep. 23, 2022, the contents of which are hereby incorporated by reference in their entirety.

### FIELD

This disclosure relates to wireless communication networks including techniques for reducing latency within wireless communication networks.

### BACKGROUND

Wireless communication networks may include user equipments (UEs), base stations, and/or other types of wireless devices capable of communicating with one another. During operation, a UE may execute extended reality (XR) applications, which may include augmented reality (AR), virtual reality (VR), and/or mixed reality (MR) applications. In order to provide an immersive experience for the user, XR applications often include real-time interaction, which benefits from low network latency.

### BRIEF DESCRIPTION OF THE DRAWINGS

The present disclosure will be readily understood and enabled by the detailed description and accompanying figures of the drawings. Like reference numerals may designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and may mean at least one, one or more, etc.

FIG. 1 is a block diagram illustrating a wireless network including a user equipment (UE) and a base station for cross-link resource triggering to minimize round trip delay in accordance with some aspects of the present disclosure.

FIG. 2 is a schematic diagram illustrating signaling between a UE and a base station for cross-link resource triggering to minimize round trip delay in accordance with some aspects of the present disclosure.

FIG. 3 is a schematic diagram illustrating cross-link resource triggering in accordance with some aspects of the present disclosure.

FIG. 4 is a schematic diagram illustrating cross-link resource triggering in accordance with some aspects of the present disclosure.

FIG. 5 is a schematic diagram illustrating cross-link resource triggering in accordance with some aspects of the present disclosure.

FIG. 6 is a flow diagram for a UE configured to perform cross-link resource triggering in accordance with some aspects of the present disclosure.

FIG. 7 is a flow diagram for a base station configured to perform cross-link resource triggering in accordance with some aspects of the present disclosure.

FIG. 8 is a flow diagram for a UE configured to perform cross-link resource triggering in accordance with some aspects of the present disclosure.

FIG. 9 is a flow diagram for a base station configured to perform cross-link resource triggering in accordance with some aspects of the present disclosure.

FIG. 10 is a logic flow diagram for a UE configured to perform cross-link resource triggering in accordance with some aspects of the present disclosure.

FIG. 11 is a logic flow diagram for a UE configured to perform cross-link resource triggering in accordance with some aspects of the present disclosure.

FIG. 12 is a logic flow diagram for a base station configured to perform cross-link resource triggering in accordance with some aspects of the present disclosure.

FIG. 13 is a schematic diagram illustrating signaling between a UE and a base station for cross-link resource triggering to minimize round trip delay in accordance with some aspects of the present disclosure.

FIG. 14 is a schematic diagram illustrating cross-link resource triggering in accordance with some aspects of the present disclosure.

FIG. 15 is a schematic diagram illustrating cross-link resource triggering in accordance with some aspects of the present disclosure.

FIG. 16 is a schematic diagram illustrating cross-link resource triggering in accordance with some aspects of the present disclosure.

FIG. 17 is a flow diagram for a UE configured to perform cross-link resource triggering in accordance with some aspects of the present disclosure.

FIG. 18 is a flow diagram for a base station configured to perform cross-link resource triggering in accordance with some aspects of the present disclosure.

FIG. 19 is a flow diagram for a UE configured to perform cross-link resource triggering in accordance with some aspects of the present disclosure.

FIG. 20 is a flow diagram for a base station configured to perform cross-link resource triggering in accordance with some aspects of the present disclosure.

FIG. 21 is a logic flow diagram for a UE configured to perform cross-link resource triggering in accordance with some aspects of the present disclosure.

FIG. 22 is a logic flow diagram for a UE configured to perform cross-link resource triggering in accordance with some aspects of the present disclosure.

FIG. 23 is an example of a radio resource control (RRC) reconfiguration message in accordance with some aspects of the present disclosure.

FIG. 24 is a block diagram illustrating a device that can be employed in accordance with some aspects of the present disclosure.

FIG. 25 is a block diagram illustrating baseband circuitry that can be employed in accordance with some aspects of the present disclosure.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

Extended reality (XR) applications have experienced significant growth in recent years. XR applications, which may include augmented reality (AR), virtual reality (VR), and mixed reality (MR) applications, are a group of applications that provide an immersive experience to the user by merging the physical and virtual worlds. XR applications are often an interactive experience by nature. The user may interact with a virtual environment within the XR applications through a user equipment (UE), and the virtual environment may change/respond according to user interaction. For example, the UE may send pose information and/or control information to a network indicating a position and orientation of the user within the virtual environment. The network may respond to the UE based on the processed pose/control information. For example, based on a position of the user within the virtual environment and an orientation (e.g., a direction the user is facing), the network may send the relevant data pertaining to that position/orientation.

Due to the interactive nature of XR applications, the UE is often required to communicate with the network, for example, by exchanging signaling with a base station. The time between sending a UL transmission and receiving the corresponding DL transmission may be referred to as round-trip time (RTT). Since the uplink (UL) data from the UE to the base station and downlink (DL) data from the base station to the UE are mutually dependent, in order to provide a smooth experience to the user, delays associated with the RTT should be minimized.

Current techniques are not optimized for applications with mutually dependent UL/DL requiring low RTT. For example, a base station may allocate resources for PDCCH transmission when a DL packet arrives in the base station buffer. The PDCCH transmission may schedule a physical downlink shared channel (PDSCH) transmission to carry the DL data. However, this technique involves two transmissions: PDCCH and PDSCH, which increases the total RTT. In addition, the UE that uses dynamic scheduling may need to monitor the PDCCH to receive the DL resource assignment under a connected mode discontinuous reception (C-DRX) operation. During the C-DRX operation, the UE may save energy by periodically alternating between monitoring (e.g. during OnDuration of the C-DRX operation) and not monitoring the PDCCH. Waiting for the OnDuration of the C-DRX operation to transmit the PDCCH may further delay the RTT.

Alternatively, the DL data may be delivered based on configured scheduling such as semi-persistent scheduling (SPS). The SPS may be provisioned and always active, and the DL data may be delivered using the provisioned resources. The amount of signaling, and thus RTT, is reduced since PDCCH scheduling is no longer required. However, since the SPS is always active, the UE must unnecessarily decode all SPS occasions, which negatively impacts energy consumption. Therefore, existing techniques only allow for a reduction in RTT at the cost of a significant loss in energy efficiency. Such a loss in energy efficiency, however, is not desired. Poor energy efficiency may decrease the battery life of the UE, thus resulting in a poor experience for the user.

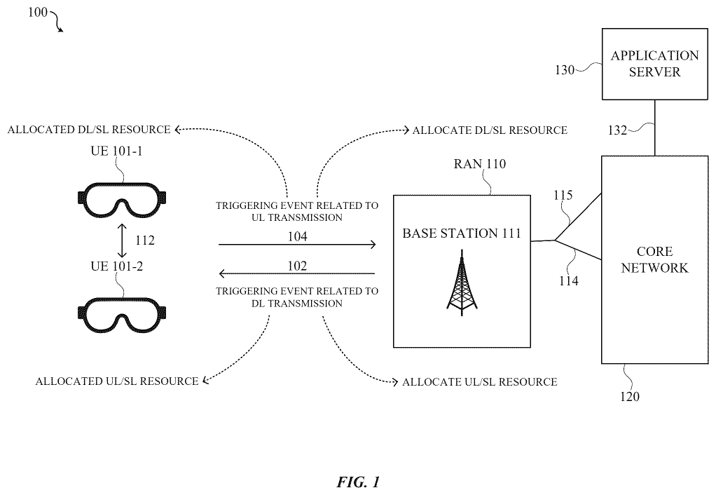

Accordingly, the present disclosure relates to techniques to minimize round trip delay while also considering UE energy efficiency via cross-link resource triggering. FIG. 1 illustrates an example architecture of a network system 100 in accordance with various aspects. The network system includes UEs 101-1, 101-2, etc. (referred to collectively as “UEs 101” and individually as “UE 101”). The UE 101 can be configured to connect, for example, communicatively couple, with a RAN 110. The RAN 110 may comprise one or more base stations 111.

The UE 101 may utilize connections (or channels) 102, 104, 112 comprising a physical communications interface/layer for DL, UL, and sidelink (SL) respectively. The base station 111 may utilize DL connection 102 to transmit a cross-link resource pre-configuration to the UE 101 to configure allocation of a cross-link resource (e.g., a UL, DL, or SL resource) in response to a triggering event. In some aspects, allocation of the resource may include activating/modifying a DL SPS resource (e.g., for DL), activating/modifying an UL configured grant (CG) resource (e.g., for UL), activating a SL resource, or entering a PDCCH monitoring mode (e.g., for UL or DL). In some aspects, the triggering event is related to a data transmission in a first direction (e.g., UL or DL). In response to the triggering event, an action related to the allocation of the cross-link resource is triggered to facilitate a data transmission in a second direction (e.g., DL/SL or UL/SL respectively).

In some aspects, in response to the triggering event, the base station 111 activates a cross-link resource, and the UE 101 considers the cross-link resource as activated. The triggering event may be detected at both the UE 101 and the base station 111, such that the cross-link resource is both activated by the base station 111 and understood to be activated by the UE 101 without the need for additional signaling. The UE 101 and the base station 111 may then use the activated cross-link resource for data transmission/reception or reception/transmission respectively. By activating the cross-link resource without exchanging additional signaling, RTT is reduced. Furthermore, activating the cross-link resource only when necessary is beneficial for UE energy efficiency.

In some aspects, the cross-link resource includes a DL or SL resource and the triggering event is related to a UL data transmission. For example, the UE 101 may detect the triggering event during preparation/transmission of the UL data, and the base station 111 may detect the triggering event upon reception/processing of the UL data. In some alternative aspects, the cross-link resource includes a UL or SL resource and the triggering event is related to a DL data transmission. For example, the base station 111 may detect the triggering event during preparation/transmission of the DL data, and the UE 101 may detect the triggering event upon reception/processing of the DL data. The triggering event is detected independently at the UE 101 and the base station 111, which enables the cross-link resource activation without the need for additional signaling.

In some aspects, the cross-link resource pre-configuration may configure allocation of a plurality of cross-link resources in response to a plurality of corresponding triggering events. The plurality of resources may each be configured according to the various techniques described herein. For example, a first UL resource may be allocated in response to a first triggering event, a second UL resource may be allocated in response to a second triggering event, a first DL resource may be allocated in response to a third triggering event, etc.

For example, in some aspects, the triggering event may include detecting a data packet from a specific logical channel (LCH). When the UE transmits UL data to the base station, reception of related DL data is expected shortly thereafter. Upon preparation or transmission of the UL data, the UE may detect the triggering event (e.g., the data packet from the specific LCH). In response, the UE may consider an SPS resource as activated to prepare for reception of the DL data. Upon reception of the UL data at the base station, the base station may recognize the same data packet from the specific LCH. The base station may have a common understanding with the UE and activate the SPS resource accordingly. The common understanding may be a result of the base station previously pre-configuring the UE. For example, when the pre-configuration is sent to the UE, the base station may retain some data (e.g., in memory) related to the pre-configuration. Based on the retained data, the base station may know the behavior of the UE in response to the triggering event. After activating the SPS resource, the base station uses the SPS resource to transmit the DL data. Since the UE has already considered the SPS resource as activated, the UE may receive the DL data using the SPS resource. By pre-configuring the UE for cross-link resource triggering, SPS may be activated without the need for additional signaling (e.g., an SPS activation command) between the UE and base station. Since signaling is reduced, round-trip delay is thereby improved.

In this example, the UEs 101 are illustrated as VR glasses, but can comprise any mobile or non-mobile computing device, such as consumer electronics devices, cellular phones, smartphones, feature phones, tablet computers, wearable computer devices, personal digital assistants (PDAs), pagers, wireless handsets, desktop computers, laptop computers, in-vehicle infotainment (IVI), in-car entertainment (ICE) devices, an Instrument Cluster (IC), head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, Machine Type Communication (MTC) devices, Machine to Machine (M2M), Internet of Things (IoT) devices, and/or the like.

In some aspects, the RAN 110 can be a next generation (NG) RAN or a 5G RAN, an evolved-UMTS Terrestrial RAN (E-UTRAN), or a legacy RAN, such as a UTRAN or GERAN. As used herein, the term “NG RAN” or the like can refer to a RAN 110 that operates in an NR or 5G system, and the term “E-UTRAN” or the like can refer to a RAN 110 that operates in an LTE or 4G system.

In some aspects, the core network (CN) 120 can be a 5GC (referred to as “5GC 120” or the like), and the RAN 110 can be connected with the CN 120 via two parts, a Next Generation (NG) user plane (NG-U) interface 114, which carries traffic data between the RAN nodes and a User Plane Function (UPF), and the S1 control plane (NG-C) interface 115, which is a signaling interface between the RAN nodes and Access and Mobility Management Functions (AMFs).

In some aspects, an application server 130 can be configured to support one or more services (e.g., XR applications, VoIP sessions, push-to-talk (PTT) sessions, group communication sessions, etc.) for the UE 101. As an example, the application server 130 may communicate with the CN 120 through an internet protocol (IP) communications interface 132. Processing latency of the application server 130 and communication latency of IP communications interface 132 may contribute to round-trip delay.

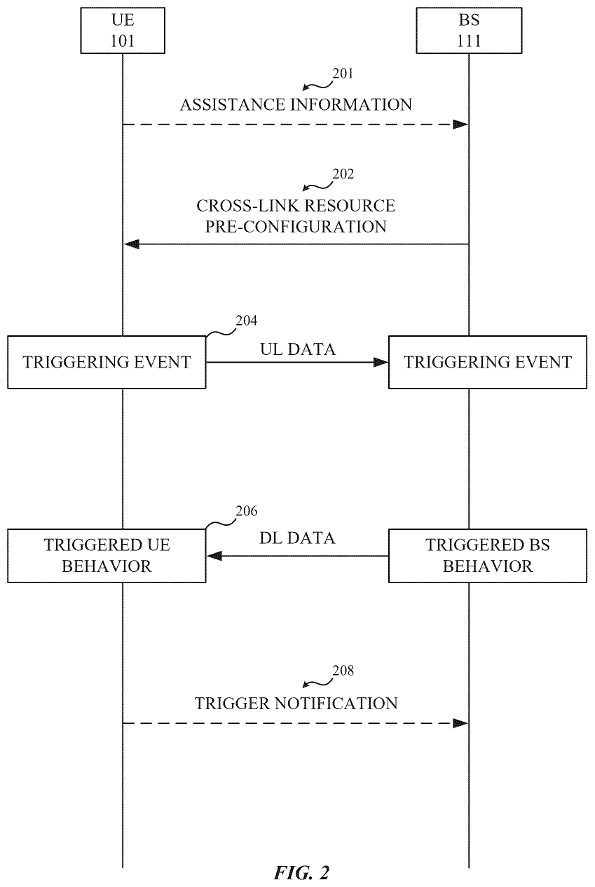

FIG. 2 illustrates signaling between a UE 101 and a base station 111 for cross-link resource triggering to minimize round trip delay in accordance with some aspects. In some aspects, a triggering event is related to an UL data transmission. In response, a DL resource is allocated.

In some aspects, the base station 111 sends a cross-link resource pre-configuration 202 to the UE 101 to pre-configure the UE 101 for cross-link resource triggering. The pre-configuration may be done via radio resource control (RRC) signaling (e.g., an RRC message) or other signaling. The cross-link resource pre-configuration 202 may configure allocation of or an action related to allocation of an UL, DL, or SL resource in response to the triggering event. The action related to the allocation may facilitate transmission or reception using the UL, DL, or SL resource.

In some aspects, the UE 101 sends UL data to the base station 111 at act 204. In some aspects, the UE 101 and the base station 111 also detect the triggering event at act 204. The triggering event may be related to the UL data transmission. From the perspective of the UE 101, the triggering event may be detected during preparation or transmission of the UL data. From the perspective of the base station 111, the triggering event may be detected upon reception or processing of the UL data from the UE 101. The triggering event may include one or more of the following conditions being met:
1. A data packet from a specific quality of service (QoS) flow, specific PDU session, specific radio bearer, or specific LCH is detected, a data packet with an urgency/critical indication is detected, or a special type of data packet such as a real-time transport control protocol (RTCP) packet is detected. Detection of a data packet may occur when the data packet arrives at or from an upper layer (e.g., service data adaptation protocol (SDAP) layer or packet data convergence protocol (PDCP) layer) from the perspective of the UE 101, or when data is received/processed from the perspective of the base station 111.
2. A MAC PDU including data (e.g., a MAC SDU) from a specific QoS flow, specific PDU session, specific radio bearer, or specific LCH is detected, a MAC PDU including a data packet with urgency/critical indication is detected, or MAC PDU including a special type of data packet such as an RTCP packet is detected. Detection of the MAC PDU may occur when the MAC PDU is prepared or to be prepared by the MAC layer, when the MAC PDU arrives at the physical layer from the perspective of the UE 101, or when the MAC PDU is received/processed from the perspective of the base station 111.
3. A SR is triggered or transmitted (from the perspective of the UE 101) or a SR is received (from the perspective of the base station 111).
4. A BSR is generated or transmitted (from the perspective of the UE 101) or a BSR is received (from the perspective of the base station 111).

In some aspects, the triggering event may have different conditions when viewed from the UE 101 and the base station 111 perspective. For example, the triggering event may be related to UL transmission and may include condition 1 being met from the perspective of the UE 101, and may include condition 2 being met from the perspective of the base station 111. In some aspects, the QoS flow, PDU session, radio bearer, or LCH may be shared between the conditions (e.g., the UE 101 detects a data packet from an LCH, and the base station 111 detects a MAC PDU from the same LCH).

In some aspects, a DL resource is allocated at act 206 in response to the triggering event from act 204. DL data is sent by the base station 111 to the UE 101 using the allocated DL resource. Allocation of the DL resource may include behavior being triggered at the UE 101 and corresponding behavior being triggered at the base station 111. The following description provides some possible examples of behavior for the UE 101 and the base station 111.

In some aspects, allocation of the DL resource includes activating a DL SPS resource. The UE 101 may consider the DL SPS resource as activated, and the base station 111 may activate the DL SPS resource. Based on the cross-link resource pre-configuration, the UE 101 and the base station 111 have a mutual understanding, and the DL SPS resource is activated without any additional signaling being exchanged, thereby reducing round-trip delay.

In some aspects, the allocation of the DL resource includes modifying a DL SPS configuration associated with the DL SPS resource. The modification may include modifying a periodicity, nrofHARQ-Processes, n1PUCCH-AN, or mcs-Table of an SPS configuration IE (e.g., SPS-Config). In some aspects, modifying the DL SPS configuration may include modifying (e.g., shortening) a periodicity of the SPS. For example, the SPS may always be active but with a long periodicity. In response to the triggering event, the UE 101 may consider the periodicity of the SPS as shortened (at least temporarily), and the base station 111 may shorten the periodicity of the SPS (at least temporarily). By originally using a longer SPS periodicity and using a shorter SPS periodicity in response to the triggering event, both energy efficiency and round-trip delay are optimized.

In some aspects, the allocation of the DL resource includes modifying the DL SPS configuration in addition to activating the DL SPS resource. For example, when the triggering event is detected, the DL SPS resource may be activated and the SPS periodicity may be shortened. If the SPS is activated by other means (e.g., an SPS activation command) then the SPS may be activated with the longer periodicity. By both activating and modifying the SPS in response to the triggering event, the SPS may be used more flexibly.

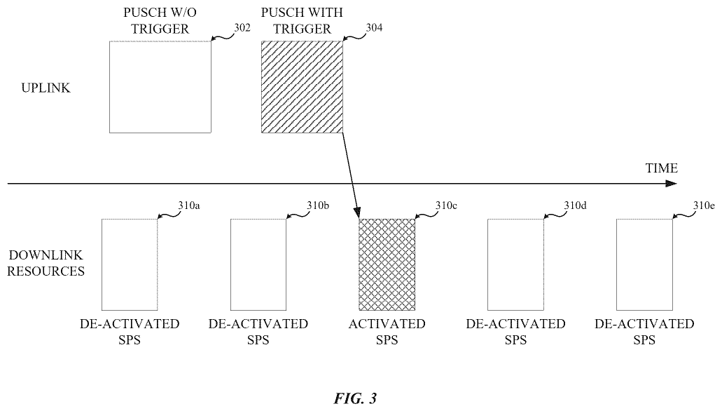

In some aspects, allocation of the DL resource includes entering/staying in a PDCCH monitoring mode. The UE 101 may stay in the PDCCH monitoring mode if the UE 101 is already monitoring the PDCCH, or enter the PDCCH monitoring mode if the UE 101 is not monitoring the PDCCH (e.g., as part of C-DRX operation). In some aspects, the UE 101 may stay in the PDCCH monitoring mode until a PDSCH allocation is received from the base station 111 (e.g., via downlink control information (DCI)). Since the PDCCH monitoring mode is entered in response to the triggering event, the UE 101 may avoid additional delay due to C-DRX operation, and the UE 101 may proceed with normal C-DRX operation once the PDCCH monitoring mode is exited. More detailed examples of possible UE and base station behaviors are described further in this disclosure with reference to FIGS. 3-12.

In some optional aspects, the UE 101 sends a trigger notification 208 to the base station 111. The trigger notification may be included in, for example, uplink control information (UCI), CG-UCI, or a MAC control element (CE). The trigger notification 208 may be transmitted on the same channel as the UL data, or on any other channel. The trigger notification 208 notifies the base station 111 that the triggering event was detected at the UE side, and may be used to confirm that the base station 111 and the UE 101 have a mutual understanding of the allocated resource. For example, if the base station 111 receives the trigger notification 208 unexpectedly, it is possible that the base station 111 did not properly receive/decode a packet, and thus the triggering event was not detected at the base station side. In this scenario, corrective measures may be taken accordingly. Although the trigger notification 208 is illustrated as being transmitted after the UL and DL data, this is merely exemplary. The trigger notification 208 may alternatively be transmitted simultaneously with the UL data, before the UL data as soon as the triggering event is detected, or between the UL and DL data transmissions.

In some aspects, the pre-configuration 202 configures resource allocation on a per LCH, per radio bearer (e.g., data radio bearer (DRB)), or per QoS flow basis. For example, on a per LCH basis, different triggering events are associated with respective different LCHs, and a different resource is allocated based on the triggering event. The pre-configuration 202 may be included, at least in part, in an information element (IE) such as a logic channel configuration IE (e.g., logicalChannelConfig for a per LCH basis) or a PDCP configuration IE (e.g., pdcp-Config for a per DRB basis). The pre-configuration 202 may further include an associated SPS resource and/or PDCCH monitoring behavior to be used in response to the triggering event.

In some optional aspects, the UE 101 sends assistance information 201 to the base station 111 before receiving the pre-configuration 202. Alternatively, the base station 111 may receive the assistance information 201 from the CN 120. The base station 111 may use the assistance information 201 to determine an optimal pre-configuration 202. The assistance information 201 may indicate a minimum and/or maximum DL payload the UE 101 can expect in response to an UL transmission and vice versa. Additionally or alternatively, the assistance information 201 may indicate a minimum and/or maximum time for DL data to be prepared in response to the UL transmission and vice versa. Such information could be conveyed per each UL/DL traffic flow pair, where the UL and DL traffic flows in each UL/DL traffic flow pair are mutually dependent.

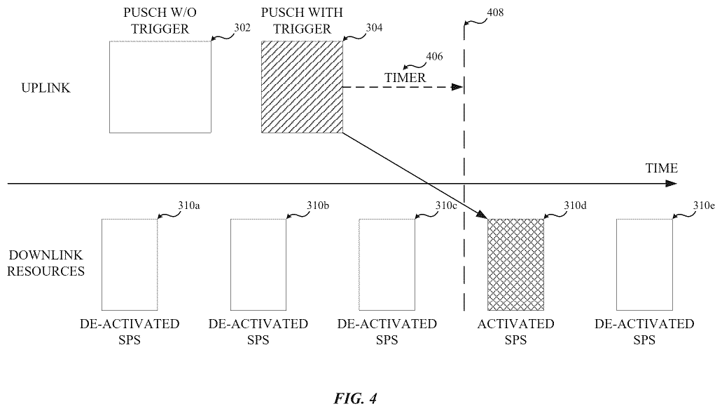

FIGS. 3 and 4 illustrate cross-link resource triggering in accordance with some aspects. In some aspects, DL resources are activated in response to an UL related event. The DL resources may comprise, for example, a plurality of DL SPS resources 310a, 310b, 310c, 310d, 310e. UL data is transmitted from a UE (e.g., UE 101) to a base station (e.g., base station 111). From the perspective of the UE, a triggering event is not detected during preparation and/or transmission of the UL data 302. Subsequently, additional UL data 304 is transmitted to the base station. The triggering event may be detected during preparation/transmission of the additional UL data 304. From the perspective of the base station, the triggering event is not detected upon reception/processing of the UL data 302, and the triggering event is detected upon reception/processing of the additional UL data 304. In some aspects, the UL data 302, 304 may be carried by a physical uplink shared channel (PUSCH).

In some aspects, as shown in FIG. 3, the base station may activate, and the UE may consider as activated, the next DL SPS resource 310c after the triggering event is detected. The DL SPS resources 310a, 310b are not activated before the triggering event. The UE may use the DL SPS resource 310c to receive DL data corresponding to the UL data 304. In some aspects, the DL SPS resources 310d, 310e are not activated, since the UE has already received the relevant DL data using the DL SPS resource 310c. The activation of the DL SPS resource 310c may be based on the cross-link resource pre-configuration, as previously described.

In some aspects, the DL SPS resources 310d or 310d, 310e are additionally activated. This additional activation may be based on the cross-link resource pre-configuration. For example, the cross-link resource pre-configuration may specify a number of SPS occasions to activate or a duration to activate SPS, and the SPS is activated for the specified number of occasions or specified duration accordingly. In some alternative aspects, the UE considers the SPS as activated until further instruction (e.g., to deactivate the SPS) is received from the base station. In some additional alternative aspects, the UE may adaptively determine by itself how many DL SPS occasions should be activated. The adaptive determination may depend on the triggering LCH, assuming the UE has at least two LCHs that can potentially trigger resource allocation.

In some aspects, as shown in FIG. 4, a timer 406 is started. The timer 406 may be started when the triggering event is detected during preparation/transmission of the UL data 304, or after the UL data 304 has been transmitted. A duration of the timer 406 may be included in or based on the cross-link resource pre-configuration.

In some aspects, the timer 406 specifies a waiting duration. For example, the timer 406 expires at a time point 408, signifying an end of the waiting duration. The next DL SPS resource 310d immediately after the time point 408 may be activated, while DL SPS resources 310a, 310b, 310c occurring before expiration of the timer 406 are not activated. Similar to FIG. 3, the DL SPS resource 310e and/or other additional DL SPS resources following the activated DL SPS resource 310d may also be activated based on the cross-link resource pre-configuration (e.g., if the pre-configuration specifies a number of SPS occasions or duration for SPS to be activated). In some aspects, the DL SPS resource 310d is only activated if no retransmission grant (e.g., negative acknowledgement (NACK)) is received while the timer is running.

In some aspects, the duration of the timer 406 is based on assistance information. For example, the assistance information may include information indicating or related to the minimum time between the UE sending UL and receiving corresponding DL. Since it is not possible for the UE to receive the DL data in less than this minimum time, the UE may wait to activate DL SPS resources in order to avoid activating unnecessary DL SPS resources. The timer 406 may be maintained at the UE, the base station, or both the UE and the base station.

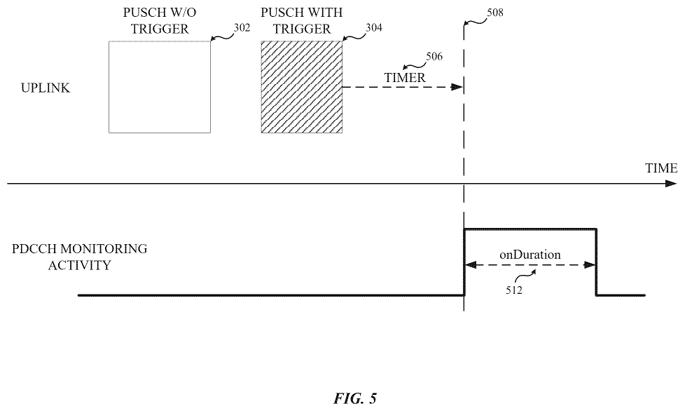

FIG. 5 illustrates cross-link resource triggering in accordance with some aspects. In some aspects, a PDCCH is monitored in response to an UL related event. UL data 302 is transmitted from a UE (e.g., UE 101) to a base station (e.g., base station 111). A triggering event is not detected during preparation/transmission (from the UE perspective) or reception/processing (from the base station perspective) of the UL data 302. Subsequently, additional UL data 304 is transmitted to the base station. The triggering event is detected during preparation/transmission of the additional UL data 304 at the UE side and during reception/processing of the additional UL data 304 at the base station side. In some aspects, the UL data 302, 304 may be carried by a PUSCH.

In some aspects, a timer 506 is started. The timer 506 may be started when the triggering event is detected during preparation/transmission of the UL data 304, or after the UL data 304 has been transmitted. A duration of the timer 506 may be indicated in the cross-link resource pre-configuration. In some aspects, the timer 506 is not used (e.g., a duration of 0). In some aspects, the timer 506 is based on assistance information, similar to timer 406 as previously described.

In some aspects, the timer 506 specifies a waiting duration. The timer 506 expires at a time point 508, signifying an end of the waiting duration. Upon expiration of the timer 506, the UE may begin monitoring the PDCCH for a duration ‘onDuration’ 512. The duration 512 may be specified in the cross-link resource pre-configuration, and may be configured individually (e.g., per LCH, per DRB, per QoS flow, etc.) or overall. In some alternative aspects, the duration 512 may be adaptively determined by the UE, for example, based on the triggering LCH.

In some aspects, the PDCCH is not monitored for the entire duration 512, and the PDCCH monitoring is ended when a PDSCH allocation is received. In some alternative aspects, the duration 512 is not used, and the PDCCH is instead monitored by the UE until further instruction is received from the base station. Additionally, if the UE is already monitoring the PDCCH when the timer 506 expires (e.g., the UE already has an onDuration) then the duration 512 can be added to the existing onDuration. In some aspects, onDuration is tracked by a timer such as drx-onDurationTimer, drx-InactivityTimer, or drx-Retransmission TimerUL.

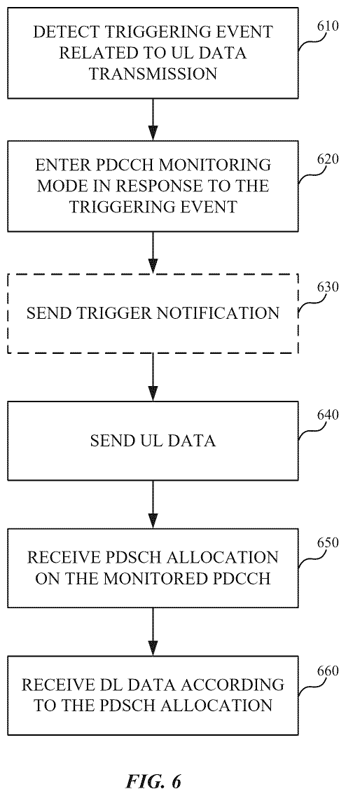

FIG. 6 is a flow diagram for a UE (e.g., UE 101) configured to perform cross-link resource triggering in accordance with some aspects. In some aspects, the UE detects a triggering event related to a UL data transmission at act 610. The UE enters a PDCCH monitoring mode at act 620 in response to the triggering event. If UE is already in a PDCCH monitoring mode, then act 620 may be skipped (e.g., the UE stays in the PDCCH monitoring mode). The UE may enter/stay in the PDCCH monitoring mode in order to receive a resource allocation for DL data (e.g., a PDSCH allocation). In some optional aspects, at act 630, a trigger notification is sent to a base station (e.g., base station 111). At act 640, the UE sends the UL data to the base station. At act 650 the UE receives a PDSCH allocation from the base station on the monitored PDCCH. Since the UE is monitoring the PDCCH, the PDSCH allocation is not missed (e.g., due to C-DRX operation). The UE then receives the DL data at act 660 using resources allocated according to the PDSCH allocation.

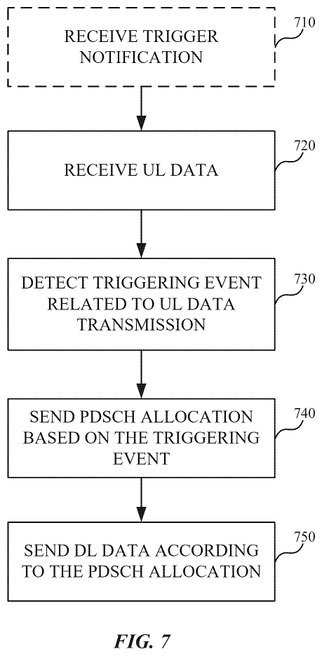

FIG. 7 is a flow diagram for a base station (e.g., base station 111) configured to perform cross-link resource triggering in accordance with some aspects. In some optional aspects, at act 710, the base station receives a trigger notification from a UE (e.g., UE 101). At act 720, the base station receives UL data from the UE. At act 730 the base station detects a triggering event related to the UL data transmission (e.g., while receiving/processing the UL data). At act 740, in response to the triggering event, the base station sends a PDSCH allocation to the UE. The base station sends DL data to the UE at act 750 using resource allocated according to the PDSCH allocation. In some aspects, the base station may have some knowledge that the UE will be monitoring the PDCCH based on the triggering event, and the PDSCH allocation may be sent earlier than otherwise possible (e.g., due to C-DRX operation).

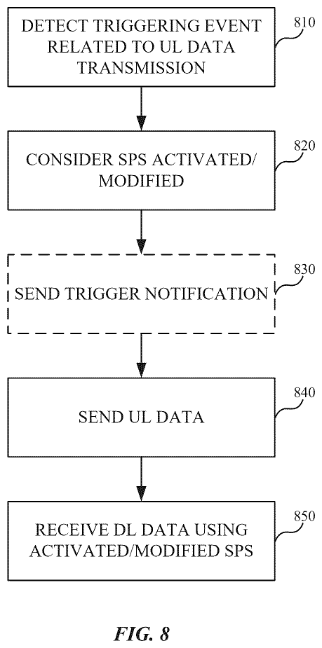

FIG. 8 is a flow diagram for a UE (e.g., UE 101) configured to perform cross-link resource triggering in accordance with some aspects. In some aspects the UE detects a triggering event related to a UL data transmission at act 810. In response, the UE considers an SPS resource as activated at act 820. Act 820 may additionally or alternatively comprise the UE considering an SPS configuration as modified (e.g., SPS periodicity is shortened). In some optional aspects, at act 830, a trigger notification is sent to the base station. The UE sends the UL data to the base station at act 840. At act 850, the UE receives the DL data using the activated/modified SPS resource.

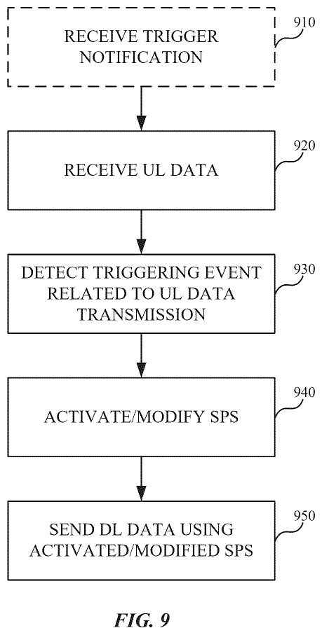

FIG. 9 is a flow diagram for a base station (e.g., base station 111) configured to perform cross-link resource triggering in accordance with some aspects. In some optional aspects, the base station receives a trigger notification from a UE (e.g., UE 101) at act 910. At act 920, the base station receives UL data from the UE. The base station detects a triggering event related to the UL data transmission at act 930 (e.g., while receiving/processing the UL data). In turn, at act 940, the base station activates the SPS resource and/or modifies the SPS configuration accordingly. The base station then sends the DL data to the UE using the activated/modified SPS resource at act 950.

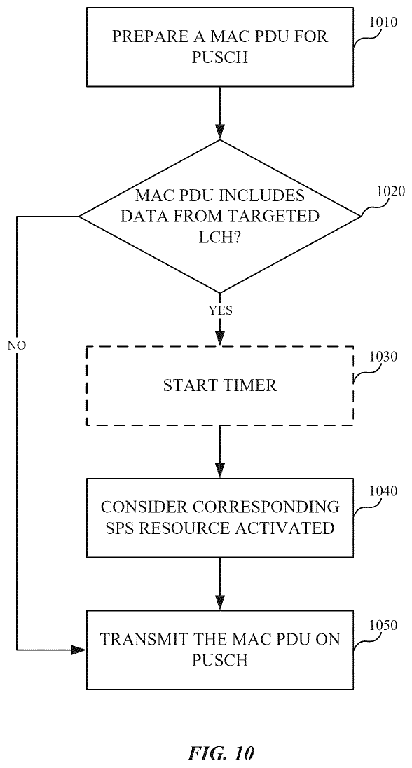

FIG. 10. is a logic flow for cross-link resource triggering at a UE (e.g., UE 101) in accordance with some aspects. In some aspects, at act 1010, the UE prepares a MAC PDU for transmission over a PUSCH. The UE may be pre-configured for resource allocation (e.g., via the cross-link resource pre-configuration) on a per LCH basis. In some aspects, at act 1020, the UE checks if the MAC PDU includes data from a targeted LCH. If the MAC PDU does not include data from the targeted LCH, then the UE proceeds with transmitting the MAC PDU on PUSCH normally at act 1050. If the MAC PDU includes data from the targeted LCH, at act 1040 the UE considers the corresponding SPS resource as activated. The corresponding SPS resource may be specified in the cross-link resource pre-configuration. Additionally or alternatively, the UE may consider an SPS configuration as modified (e.g., periodicity is reduced). The UE then transmits the MAC PDU on PUSCH at act 1050.

In some optional aspects, the UE may start a timer at act 1030, and only activate the SPS resource after expiration of the timer. Although acts 1030, 1040, and 1050 are illustrated in a certain sequence, it is appreciated that the sequence of these acts may change based on the various techniques described herein. For example, if the timer used at act 1030 is long enough, the MAC PDU may be transmitted at act 1050 before considering the SPS resource as active at act 1040.

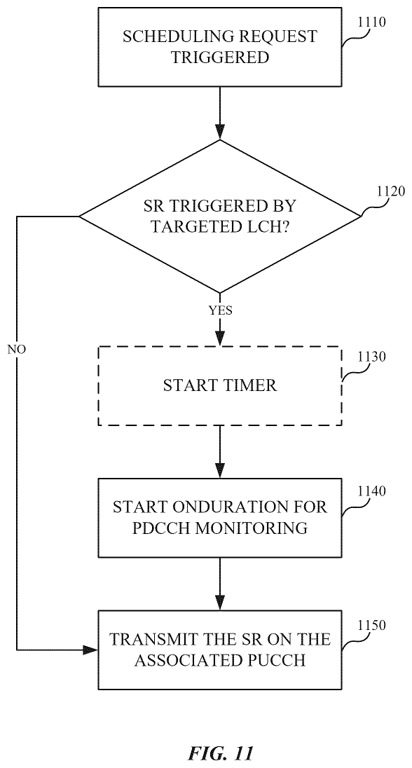

FIG. 11. is a logic flow for cross-link resource triggering at a UE (e.g., UE 101) in accordance with some aspects. In some aspects, at act 1110, a SR is triggered. The UE may be pre-configured for resource allocation (e.g., via the cross-link resource pre-configuration) on a per LCH basis.

In some aspects, at act 1120, the UE checks if the SR was triggered by a targeted LCH. If the SR was not triggered by the targeted LCH, then the UE proceeds with transmitting the SR on associated PUCCH at act 1150. If the SR was triggered by the targeted LCH, at act 1140, the UE starts to monitor the PDCCH for a duration ‘onDuration’. The UE then transmits the SR on the associated PUCCH at act 1150.

In some optional aspects, the UE may start a timer at act 1130, and only begin monitoring the PDCCH after expiration of the timer. Although acts 1130, 1140, and 1150 are illustrated in a certain sequence, the sequence of these acts may change based on the various techniques described herein. For example, if the timer used at act 1130 is long enough, the SR may be transmitted at act 1150 before the PDCCH monitoring mode is entered at act 1140.

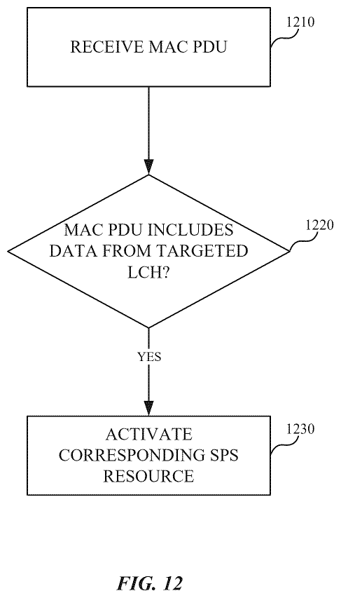

FIG. 12 is a logic flow for cross-link resource triggering at a base station (e.g., base station 111) in accordance with some aspects. In some aspects, the base station previously pre-configured the UE for resource allocation (e.g., via the cross-link resource pre-configuration) on a per LCH basis.

In some aspects, the base station receives a MAC PDU at act 1210. At act 1220, the base station checks if the MAC PDU includes data from a targeted LCH. The targeted LCH may be specified in the pre-configuration. If the MAC PDU includes data from the targeted LCH, then the base station activates the corresponding SPS resource at act 1230 as specified in the pre-configuration.

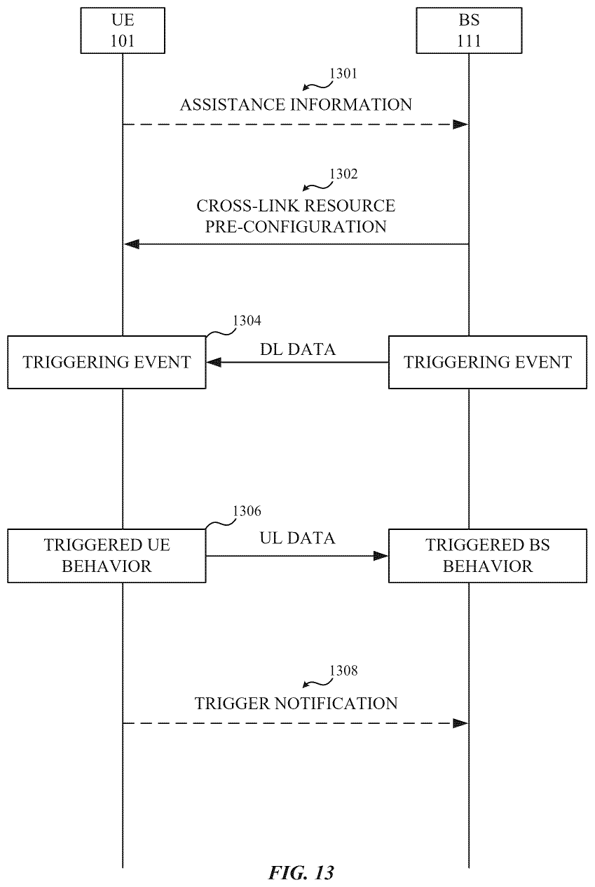

FIG. 13 illustrates signaling between a UE 101 and a base station 111 for cross-link resource triggering to minimize round trip delay in accordance with some aspects. In some aspects, the triggering event is related to a DL data transmission. In response, a UL resource is allocated.

In some aspects, the base station 111 sends a cross-link resource pre-configuration 1302 to the UE 101. The cross-link resource pre-configuration 1302 may be the cross-link resource pre-configuration previously described, and may configure allocation of an UL, DL, or SL resource in response to a triggering event. In some aspects, the pre-configuration 1302 configures resource allocation on a per CG configuration or per MAC entity basis. For example, on a per CG configuration basis, different triggering events are associated with respective CG configurations. The UL CG resource may be activated when a corresponding triggering event is detected. The pre-configuration may be included, at least in part, in an IE such as configuredGrantConfig (e.g., for a per CG configuration basis). In some aspects, the configuration may include a list of indices of DL LCHs that can trigger activation of a UL CG. The pre-configuration 1302 may further include an associated SPS resource and/or PDCCH monitoring behavior to be used in response to the triggering event.

In some optional aspects, the UE 101 sends assistance information 1301 to the base station 111 before receiving the pre-configuration 1302. The base station 111 may use the assistance information to determine an optimal pre-configuration 1302. The assistance information 1301 may be the assistance information as previously described.

In some aspects, the UE 101 receives DL data at act 1304. In some aspects, the UE 101 and the base station 111 also detect the triggering event at act 1304. In some aspects, the triggering event may be related to a DL transmission. The triggering event may include detecting a data packet from a specific QoS flow, specific PDU session (e.g., a specific PDU session ID), specific radio bearer, or specific LCH, detecting a data packet with an urgency/critical indication, or detecting a special type of data packet such as an RTCP packet. Detecting the data packet may occur when the data packet is received/processed from the perspective of the UE 101, or when the data packet is prepared/transmitted from the perspective of the base station 111.

In some aspects, a UL resource is allocated at act 1306 in response to the triggering event from act 1304. UL data is sent by the UE 101 to the base station 111 using the allocated UL resource. Allocation of the UL resource may include behavior being triggered at the UE 101 and corresponding behavior being triggered at the base station 111. The following description provides some possible examples of behavior for the UE 101 and the base station 111.

In some aspects, allocation of the UL resource includes activating a UL CG resource. The UE 101 may consider the UL CG resource as activated, and the base station 111 may activate the UL CG resource. Based on the cross-link resource pre-configuration, the UE 101 and the base station 111 have a mutual understanding, and the UL CG resource is activated without any additional signaling being exchanged, thereby reducing round-trip delay.

In some aspects, the allocation of the UL resource additionally or alternatively includes modifying a UL CG configuration (e.g., in an IE configuredGrantConfig) associated with the UL CG resource. In some aspects, the modification may include shortening a periodicity of the CG. For example, the CG may always be active but with a long periodicity. In response to the triggering event, the UE 101 may consider the periodicity of the CG as shortened, and the base station 111 may shorten the periodicity of the CG. By originally using a longer CG periodicity and using a shorter CG periodicity in response to the triggering event, both energy efficiency and round-trip delay are optimized.

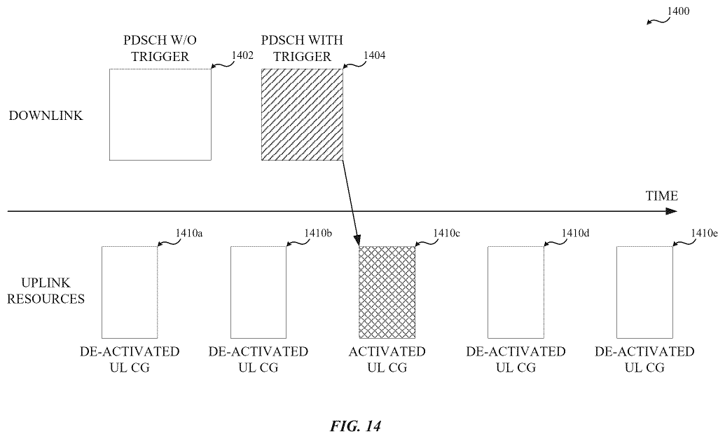

In some aspects, allocation of the UL resource includes entering/staying in a PDCCH monitoring mode. The UE 101 may stay in the PDCCH monitoring mode if the UE 101 is already monitoring the PDCCH, or enter the PDCCH monitoring mode if the UE 101 is not monitoring the PDCCH (e.g., as part of C-DRX operation). In some aspects, the UE 101 may stay in the PDCCH monitoring mode until a PUSCH allocation is received (e.g., via downlink control information (DCI)) from the base station 111. Since the PDCCH monitoring mode is entered in response to the triggering event, the UE 101 may avoid missing the PUSCH allocation due to C-DRX operation, and the UE 101 may proceed with normal C-DRX operation once the PDCCH monitoring mode is exited. More detailed examples of UE and base station behavior are described further in this disclosure with reference to FIGS. 14-22.

In some optional aspects, a trigger notification 1308 is sent to the base station 111. The trigger notification 1308 may be sent via UCI, CG-UCI, a MAC CE, or the like. The trigger notification 1308 may be transmitted on the same channel as the UL data, or on any other channel.

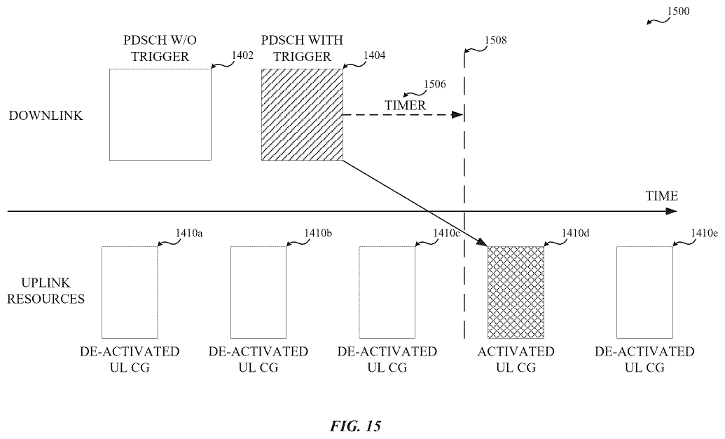

FIGS. 14 and 15 illustrate cross-link resource triggering in accordance with some aspects. In some aspects, UL resources are activated in response to a DL related event. The UL resources may comprise a plurality of UL CG resources 1410a, 1410b, 1410c, 1410d, 1410e. DL data 1402 is transmitted from a base station (e.g., base station 111) to a UE (e.g., UE 101). From the perspective of the UE, a triggering event is not detected upon reception/processing of the DL data 1402. Subsequently, the UE receives additional DL data 1404, and the triggering event is detected during reception/processing of additional DL data 1404. From the perspective of the base station, the triggering event is detected during preparation/transmission of the additional DL data 1404.

In some aspects, as shown in FIG. 14, the base station may activate, and the UE may consider as activated, the next UL CG resource 1410c. The UL CG resources 1410a, 1410b are not activated before the triggering event. The UE may use the UL CG resource 1410c to send UL data corresponding to the DL data 1404. In some aspects, the UL CG resources, 1410d, 1410e are not activated, since the UE has already sent the relevant UL data using the UL CG resource 1410c. The activation of UL CG resource 1410c may be based on the cross-link resource pre-configuration, as previously described.

In some aspects, the UL CG resources 1410d or 1410d, 1410e are additionally activated. This additional activation may be based on the cross-link resource pre-configuration. For example, the cross-link resource pre-configuration may specify a number of UL CG occasions to activate or a duration to activate CG, and the UL CG is activated for the specified number of occasions or the specified duration. In some alternative aspects, the UE considers the UL CG resources as activated until further instruction (e.g., a deactivation command) is received from the base station. In some additional alternative aspects, the UE adaptively determines by itself how many UL CG occasions should be activated. The adaptive determination may be made based on the triggering LCH, assuming the UE has at least two LCHs that can trigger resource allocation.

In some aspects, as shown in FIG. 15, a timer 1506 is started. The timer 1506 may be started when the triggering event is detected during reception/processing of the DL data 1404, or after the DL data 1404 has been processed. A duration of the time 1506 may be included in or based on the cross-link resource pre-configuration.

In some aspects, the timer 1506 specifies a waiting duration. The timer 1506 expires at 1508, signifying the end of the waiting duration. The next UL CG resource 1410d is activated. UL CG resources 1410a, 1410b, 1410c are not activated, since they occur before expiration of the timer. Similar to FIG. 14, the UL CG resource 1410e may also be activated based on the cross-link resource pre-configuration (e.g., if the pre-configuration specifies a number of CG occasions or a duration for CG to be activated). In some aspects, the duration of the timer 1506 is based on assistance information. The timer 1506 may be maintained at the UE, the base station, or both the UE and the base station.

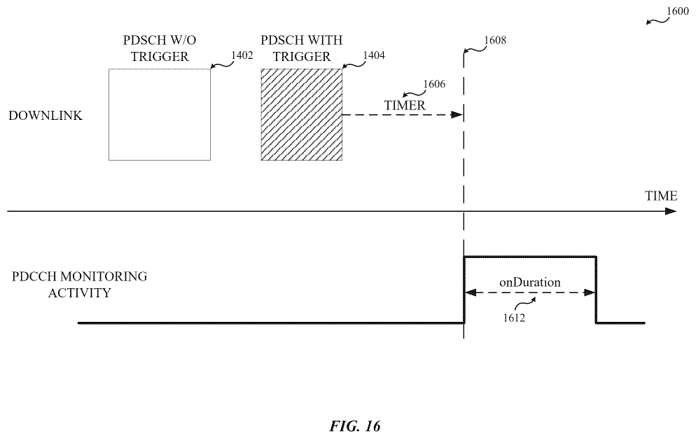

FIG. 16 illustrates cross-link resource triggering in accordance with some aspects. In some aspects, a PDCCH is monitored in response to a DL related event. DL data 1402 may be transmitted from a base station (e.g., base station 111) to a UE (e.g., UE 101). A triggering event is not detected during preparation/transmission (from the base station perspective) or reception/processing (from the UE perspective) of the DL data 1402. The triggering event is detected during preparation/transmission of the DL data 1404 at the base station side and during reception/processing of the DL data 1404 at the UE side. In some aspects, the DL data 1402, 1404 may be carried by a PDSCH.

In some aspects, a timer 1606 is started. The timer 1606 may be started when the triggering event is detected during reception/processing of the DL data 1404, or after the DL data 1404 has been processed. A duration of the timer 1606 may be indicated in the cross-link resource pre-configuration. In some aspects, the timer 1606 is not used (e.g., a duration of 0). In some aspects, the timer 1606 is based on assistance information, similar to timer 1506 as previously described.

In some aspects, the timer 1606 specifies a waiting duration. The timer 1606 expires at 1608, signifying the end of the waiting duration. Upon expiration of the timer 1606, the UE may begin monitoring the PDCCH for a duration ‘onDuration’ 1612. The duration 1612 may be specified in the cross-link resource pre-configuration, and may be configured individually (e.g., per LCH, per DRB, per QoS flow, etc.) or overall. In some alternative aspects, the duration 1612 may be adaptively determined by the UE, for example, based on the triggering LCH.

In some aspects, the PDCCH is not monitored for the entire duration 1612, and the PDCCH monitoring mode is ended when a PUSCH allocation is received. In some alternative aspects, the duration 1612 is not used, and the PDCCH is monitored by the UE until further instruction is received from the base station. Additionally, if the UE is already monitoring the PDCCH when the timer 1606 expires (e.g., the UE already has an onDuration) then the duration 1612 can be added to the existing onDuration. In some aspects, onDuration is tracked by a timer such as drx-onDuration Timer, drx-InactivityTimer, or drx-Retransmission TimerUL.

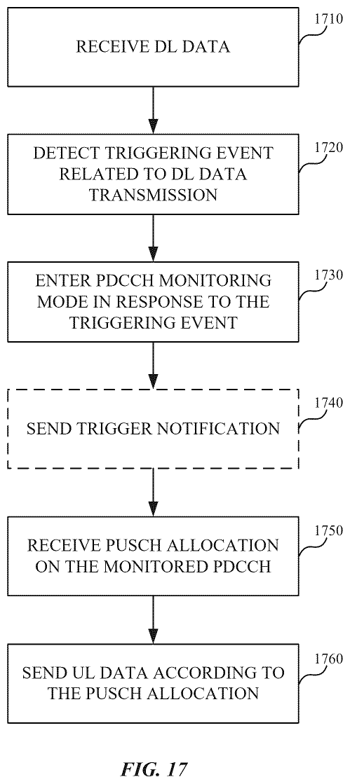

FIG. 17 is a flow diagram for a UE (e.g., UE 101) configured to perform cross-link resource triggering in accordance with some aspects of the present disclosure. In some aspects, at act 1710, the UE receives DL data from a base station (e.g., base station 111). At act 1720, the UE detects a triggering event related to the DL data transmission (e.g., during reception/processing of the DL data). At act 1730, in response to the triggering event, the UE enters a PDCCH monitoring mode. The UE may enter the PDCCH monitoring mode in order to receive a resource allocation for UL data (e.g., a PUSCH allocation). In some optional aspects, the UE sends a trigger notification to the base station at act 1740. The UE receives a PUSCH allocation at act 1750 on the monitored PDCCH and sends UL data at act 1760 using the resources according to the PUSCH allocation.

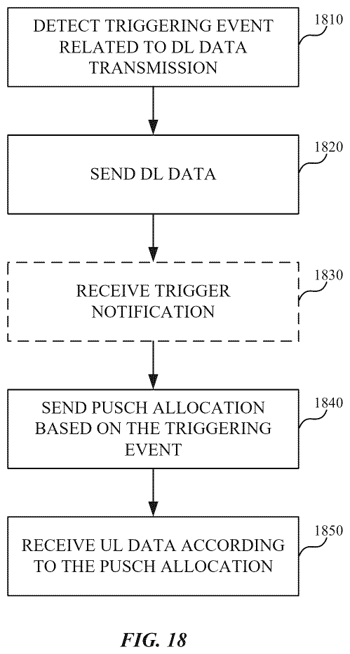

FIG. 18 is a flow diagram for a base station (e.g., base station 111) configured to perform cross-link resource triggering in accordance with some aspects of the present disclosure. In some aspects, at act 1810, the base station detects a triggering event related to a DL data transmission (e.g., during preparation of DL data for transmission). The base station sends the DL data to a UE (e.g., UE 101) at act 1820. In some optional aspects, the base station receives a trigger notification from the UE at act 1830. The base station sends a PUSCH allocation to the UE at act 1840. At act 1850, the base station receives UL data from the UE using resources allocated by the PUSCH allocation. In some aspects, the base station may have some knowledge that the UE will be monitoring the PDCCH based on the triggering event, and the PDSCH allocation may be sent earlier than otherwise possible (e.g., due to C-DRX operation).

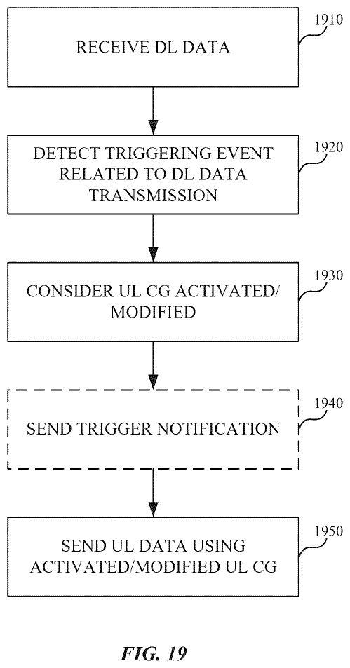

FIG. 19 is a flow diagram for a UE (e.g., UE 101) configured to perform cross-link resource triggering in accordance with some aspects of the present disclosure. In some aspects, at act 1910, the UE receives DL data from a base station (e.g., base station 111). At act 1920, the UE detects a triggering event related to the DL data transmission (e.g., during reception/processing of the DL data). In response, the UE considers a UL CG resource as activated and/or modified at act 1930. In some optional aspects, the UE sends a trigger notification to the base station at act 1940. The UE then sends UL data at act 1950 using the activated/modified UL CG resource.

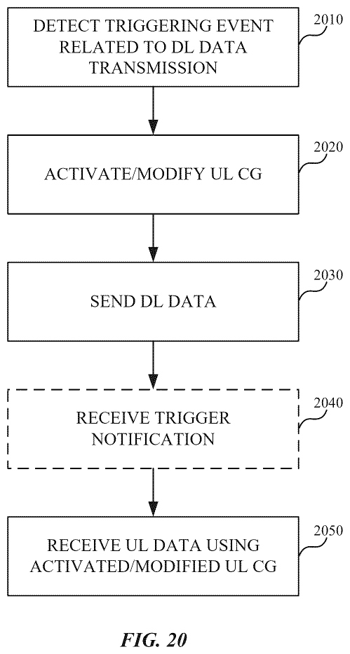

FIG. 20 is a flow diagram for a base station (e.g., base station 111) configured to perform cross-link resource triggering in accordance with some aspects of the present disclosure. In some aspects, at act 2010, the base station detects a triggering event related to a DL data transmission (e.g., during preparation of DL data for transmission). At act 2020, in response to the triggering event, the base station activates and/or modifies a UL CG resource. At act 2030, the base station sends the DL data to a UE (e.g., UE 101). In some optional aspects, at act 2040, the base station receives a trigger notification from the UE. At act 2050, the base station receives UL data from the UE using the activated/modified UL CG resource.

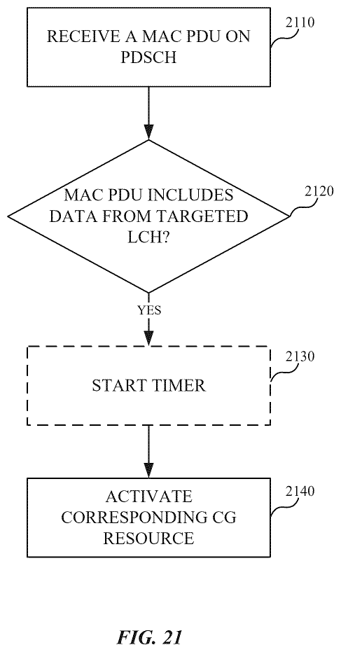

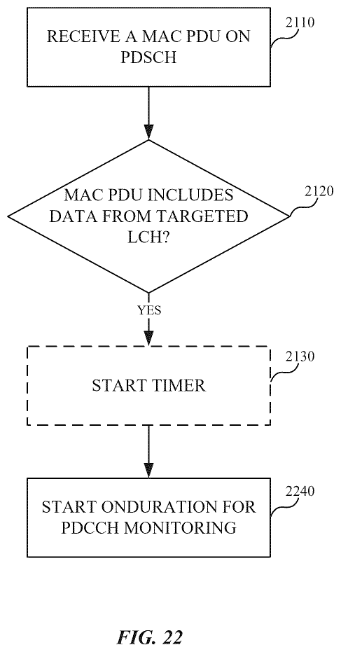

FIGS. 21 and 22 are logic flows for cross-link resource triggering at a UE (e.g., UE 101) in accordance with some aspects. In some aspects, at act 2110, the UE receives a MAC PDU on a PDSCH. The UE may be pre-configured for resource allocation (e.g., via the cross-link resource pre-configuration) on a per LCH basis.

In some aspects, at act 2120, the UE checks if the MAC PDU includes data from the targeted LCH. In some aspects, as shown in FIG. 21, if the MAC PDU includes data from the targeted LCH, then the UE may activate the corresponding CG resource at act 2140 according to the cross-link resource pre-configuration. In some alternative aspects, as shown in FIG. 22, if the MAC PDU includes data from the targeted LCH, then the UE may start monitoring a PDCCH at act 2240 for a duration ‘onDuration’. In some optional aspects, the UE starts a timer at act 2130, and proceeds to act 2140 or act 2240 upon expiration of the timer.

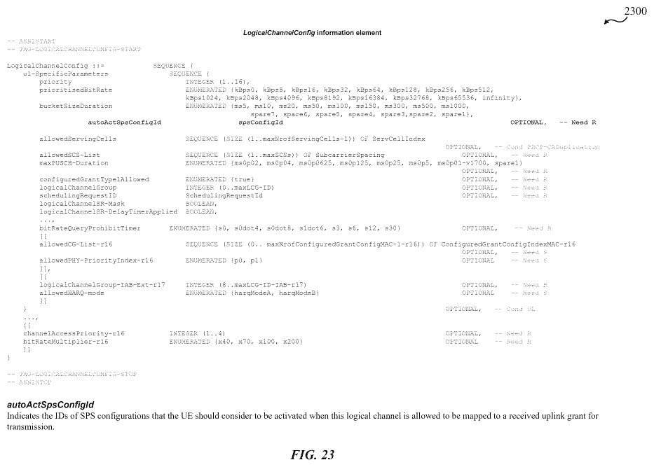

FIG. 23 is an example of a radio resource control (RRC) reconfiguration message in accordance with some aspects. In some aspects, a resource triggering parameter (e.g., ‘autoActSpsConfigId’) is included in an IE (e.g., ‘LogicalChannelConfig’) 2300. The IE may be configured on a per LCH basis. As an example, the resource triggering parameter may specify which SPS configurations (e.g., which SPS configuration identities (IDs)) the UE should consider as active when the respective LCH is allowed to be mapped to a received UL grant for transmission.

Examples herein can include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

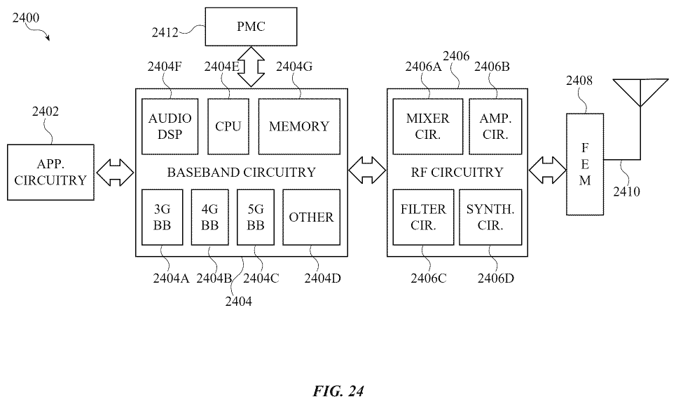

FIG. 24 is a diagram illustrating example components of a device 2400 that can be employed in accordance with some aspects of the present disclosure. In some aspects, the device 2400 can include application circuitry 2402, baseband circuitry 2404, Radio Frequency (RF) circuitry 2406, front-end module (FEM) circuitry 2408, one or more antennas 2410, and power management circuitry (PMC) 2412 coupled together at least as shown. The components of the illustrated device 2400 can be included in a UE or a RAN node such as the UE 101 or the base station 111 as described throughout the present disclosure. In some implementations, the device 2400 can include fewer elements (e.g., a RAN node may not utilize application circuitry 2402 and instead include a processor/controller to process IP data received from a CN, which may be a 5GC or an Evolved Packet Core (EPC)). In some implementations, the device 2400 can include additional elements such as, for example, memory/storage, display, camera, sensor (including one or more temperature sensors, such as a single temperature sensor, a plurality of temperature sensors at different locations in device 2400, etc.), or input/output (I/O) interface. In other implementations, the components described below can be included in more than one device (e.g., said circuitries can be separately included in more than one device for Cloud-RAN (C-RAN) implementations).

The application circuitry 2402 can include one or more application processors. For example, the application circuitry 2402 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 2400. In some implementations, processors of application circuitry 2402 can process IP data packets received from an EPC.

The baseband circuitry 2404 can include circuitry such as, but not limited to, one or more single-core or multi-core processors. The baseband circuitry 2404 can include one or more baseband processors or control logic to process baseband signals received from a receive signal path of the RF circuitry 2406 and to generate baseband signals for a transmit signal path of the RF circuitry 2406. Baseband circuitry 2404 can interface with the application circuitry 2402 for generation and processing of the baseband signals and for controlling operations of the RF circuitry 2406. For example, in some implementations, the baseband circuitry 2404 can include a 3G baseband processor 2404A, a 4G baseband processor 2404B, a 5G baseband processor 2404C, or other baseband processor(s) 2404D for other existing generations, generations in development or to be developed in the future (e.g., 2G, 6G, etc.).

The baseband circuitry 2404 (e.g., one or more of baseband processors 2404A-D) can handle various radio control functions that enable communication with one or more radio networks via the RF circuitry 2406. In other implementations, some or all of the functionality of baseband processors 2404A-D can be included in modules stored in the memory 2404G and executed via a Central Processing Unit (CPU) 2404E. The radio control functions can include, but are not limited to, signal modulation/demodulation, encoding/decoding, radio frequency shifting, etc. In some implementations, the baseband circuitry 2404 can include one or more audio digital signal processor(s) (DSP) 2404F.

RF circuitry 2406 can enable communication with wireless networks using modulated electromagnetic radiation through a non-solid medium. In various implementations, the RF circuitry 2406 can include switches, filters, amplifiers, etc. to facilitate the communication with the wireless network. RF circuitry 2406 can include a receive signal path which can include circuitry to down-convert RF signals received from the FEM circuitry 2408 and provide baseband signals to the baseband circuitry 2404. RF circuitry 2406 can also include a transmit signal path which can include circuitry to up-convert baseband signals provided by the baseband circuitry 2404 and provide RF output signals to the FEM circuitry 2408 for transmission.

In some implementations, the receive signal path of the RF circuitry 2406 can include mixer circuitry 2406A, amplifier circuitry 2406B and filter circuitry 2406C. In some implementations, the transmit signal path of the RF circuitry 2406 can include filter circuitry 2406C and mixer circuitry 2406A. RF circuitry 2406 can also include synthesizer circuitry 2406D for synthesizing a frequency for use by the mixer circuitry 2406A of the receive signal path and the transmit signal path.

The baseband circuitry 2404, or the one or more baseband processors or control logic of the baseband circuitry 2404, may stand alone as the UE 101 or the base station 111 perform signaling and operation in the meaning as described throughout this disclosure.

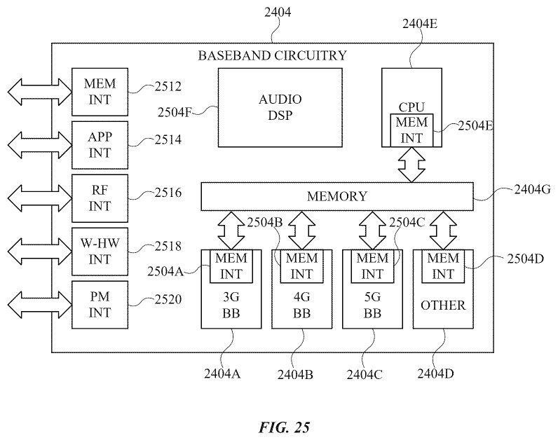

FIG. 25 illustrates a diagram illustrating example interfaces of baseband circuitry that can be employed in accordance with some aspects. As discussed above, the baseband circuitry 2404 of FIG. 24 can comprise processors 2404A-2404E and a memory 2404G utilized by said processors. Each of the processors 2404A-2404E can include a memory interface, 2504A-2504E, respectively, to send/receive data to/from the memory 2404G.

The baseband circuitry 2404 can further include one or more interfaces to communicatively couple to other circuitries/devices, such as a memory interface 2512 (e.g., an interface to send/receive data to/from memory external to the baseband circuitry 2404), an application circuitry interface 2514 (e.g., an interface to send/receive data to/from the application circuitry 2402 of FIG. 24), an RF circuitry interface 2516 (e.g., an interface to send/receive data to/from RF circuitry 2406 of FIG. 24), a wireless hardware connectivity interface 2518 (e.g., an interface to send/receive data to/from Near Field Communication (NFC) components, Bluetooth® components (e.g., Bluetooth® Low Energy), Wi-Fi® components, and other communication components), and a power management interface 2520 (e.g., an interface to send/receive power or control signals to/from the PMC 2412).

Example 1 is an apparatus for a User Equipment (UE) comprising a memory and a processor coupled to the memory, the processor is configured to execute instructions stored in the memory to cause the UE to: receive a cross-link resource pre-configuration from a base station to pre-configure an action related to a cross-link resource allocation in response to a triggering event related to a data transmission or reception in a first direction, detect the triggering event, and trigger the action related to the cross-link resource allocation to facilitate a reception or a transmission of data in a second direction using the cross-link resource.

Example 2 comprises the subject matter of any variation of example 1, wherein the first direction is an uplink (UL) direction and the second direction is a downlink (DL) or sidelink (SL) direction, or the first direction is a DL direction and the second direction is a UL or SL direction.

Example 3 comprises the subject matter of any variation of example 1, wherein the action comprises considering a downlink (DL) semi persistent scheduling (SPS) resource as activated.

Example 4 comprises the subject matter of any variation of example 3, wherein the DL SPS resource is considered as activated upon detection of the triggering event.

Example 5 comprises the subject matter of any variation of example 3, wherein the DL SPS resource is considered as activated after a waiting duration, wherein the waiting duration begins after receiving or transmitting the data, and wherein the waiting duration is configured by the cross-link resource pre-configuration.

Example 6 comprises the subject matter of any variation of example 1, wherein the action comprises considering a downlink (DL) semi persistent scheduling (SPS) configuration associated with a DL SPS resource as modified.

Example 7 comprises the subject matter of any variation of example 6, wherein considering the DL SPS configuration as modified comprises considering an SPS periodicity as modified.

Example 8 comprises the subject matter of any variation of example 1, wherein the action comprises activating a sidelink resource.

Example 9 comprises the subject matter of any variation of example 1, wherein the action comprises entering or staying in a PDCCH monitoring mode until a physical downlink shared channel (PDSCH) allocation is received.

Example 10 comprises the subject matter of any variation of example 1, wherein the action comprises considering an uplink (UL) configured grant (CG) resource as activated.

Example 11 comprises the subject matter of any variation of example 1, wherein the action comprises considering a uplink (UL) configured grant (CG) configuration associated with a UL CG resource as modified.

Example 12 comprises the subject matter of any variation of example 11, wherein considering the UL CG configuration as modified comprises considering a UL CG periodicity as modified.

Example 13 is an apparatus for a base station comprising a memory and a processor coupled to the memory, the processor is configured to execute instructions stored in the memory to cause the base station to: detect a triggering event related to an uplink (UL) data transmission from a User Equipment (UE), in response to the triggering event, trigger an action related to an allocation of a downlink (DL) resource for transmission of DL data, and transmit the DL data to the UE using the allocated DL resource.

Example 14 comprises the subject matter of any variation of example 13, wherein the triggering event includes receiving a medium access control (MAC) protocol data unit (PDU) comprising at least one MAC service data unit (SDU) from one of: a specific quality of service (QoS) flow, a specific PDU session, a specific data radio bearer (DRB), a specific logical channel (LCH), or a specific PDU session identity (ID).

Example 15 comprises the subject matter of any variation of example 13, wherein the triggering event includes receiving a scheduling request (SR) associated with a specific logical channel (LCH) or a buffer status report (BSR) associated with the specific LCH.

Example 16 comprises the subject matter of any variation of examples 13-15, wherein the action includes activating a semi persistent scheduling (SPS) resource, modifying the SPS resource, or allocating the DL resource via downlink control information (DCI).

Example 17 comprises the subject matter of any variation of examples 13-16, wherein the processor is further configured to cause the base station to receive assistance information from the UE or a core network (CN), wherein the assistance information assists the allocation of the DL resource.

Example 18 comprises the subject matter of any variation of example 17, wherein the assistance information comprises one or more of: a minimum DL payload, a maximum DL payload, a minimum DL preparation time, and a maximum DL preparation time.

Example 19 comprises the subject matter of any variation of examples 17 or 18, wherein the processor is further configured to cause the base station to send a cross-link resource triggering pre-configuration to the UE to pre-configure a UE action related to the allocation of the DL resource in response to a triggering event at the UE, wherein the cross-link resource triggering pre-configuration is based on the assistance information.

Example 20 is an apparatus for a User Equipment (UE) comprising a memory and a processor coupled to the memory, the processor is configured to execute instructions stored in the memory to cause the UE to: receive a cross-link resource triggering pre-configuration from a base station to pre-configure an action related to an allocation of a downlink (DL) or sidelink (SL) resource in response to a triggering event related to an uplink (UL) data transmission, detect the triggering event, and trigger the action to facilitate reception of data using the DL or SL resource.

Example 21 comprises the subject matter of any variation of example 20, wherein the action comprises considering a downlink (DL) semi persistent scheduling (SPS) resource as activated.

Example 22 comprises the subject matter of any variation of example 21, wherein the processor further causes the UE to monitor the DL SPS resource for an adaptively determined number of SPS occasions, wherein the adaptive determination is based on a logical channel (LCH) associated with the triggering event.

Example 23 comprises the subject matter of any variation of example 21, wherein the DL SPS resource is considered as activated after a waiting duration, wherein the waiting duration begins after transmitting the data, and wherein the waiting duration is configured by the cross-link resource pre-configuration.

Example 24 comprises the subject matter of any variation of example 20, wherein the action comprises considering a downlink (DL) semi persistent scheduling (SPS) configuration associated with a DL SPS resource as modified, wherein considering the DL SPS configuration as modified comprises considering an SPS periodicity as modified.

Example 25 comprises the subject matter of any variation of example 20, wherein the action comprises entering or staying in a PDCCH monitoring mode until a physical downlink shared channel (PDSCH) allocation is received.

Example 26 comprises the subject matter of any variation of example 20, wherein the action comprises entering a PDCCH monitoring mode, and wherein the processor further causes the UE to stay in the PDCCH monitoring mode for a monitoring duration, wherein the monitoring duration is configured by the cross-link resource pre-configuration.

Example 27 comprises the subject matter of any variation of example 20, wherein the action comprises entering a PDCCH monitoring mode, and wherein the processor further causes the UE to stay in the PDCCH monitoring mode for a monitoring duration, wherein the monitoring duration is adaptively determined based on a logical channel (LCH) associated with the triggering event.

Example 28 comprises the subject matter of any variation of example 20, wherein the action comprises entering a PDCCH monitoring mode, and wherein the processor further causes the UE to enter or stay in the PDCCH monitoring mode after a waiting duration, wherein the waiting duration begins after transmitting or receiving the data, and wherein the waiting duration is configured by the cross-link resource pre-configuration.

Example 29 comprises the subject matter of any variation of examples 20-28, wherein the processor further causes the UE to: after detecting the triggering event, transmitting a notification message indicating that the triggering event was detected.

Example 30 comprises the subject matter of any variation of example 29, wherein the notification message is transmitted on a same channel as the UL data transmission.

Example 31 comprises the subject matter of any variation of examples 29 or 30, wherein the notification message and the triggering event are both associated with one of: a specific quality of service (QOS) flow, a specific protocol data unit (PDU) session identity (ID), a specific data radio bearer (DRB), a specific logical channel (LCH), a scheduling request (SR), or a buffer status report (BSR).

Example 32 is an apparatus for a User Equipment (UE) comprising a memory and a processor coupled to the memory, the processor is configured to execute instructions stored in the memory to cause the UE to: receive a cross-link resource triggering pre-configuration from a base station to pre-configure an action related to an allocation of an uplink (UL) or sidelink (SL) resource in response to a triggering event related to a downlink (DL) data reception, detect the triggering event, and trigger the action to facilitate transmission of data using the UL or SL resource.

Example 33 comprises the subject matter of any variation of example 32, wherein the action comprises considering an uplink (UL) configured grant (CG) resource as activated.

Example 34 comprises the subject matter of any variation of example 32, wherein the action comprises considering an uplink (UL) configured grant (CG) configuration associated with a UL CG resource as modified, wherein considering the UL CG configuration as modified comprises considering an UL CG periodicity as modified.

Example 35 comprises the subject matter of any variation of examples 33-36, wherein the triggering event comprises receiving a packet from one of: a specific quality of service (QoS) flow, a specific protocol data unit (PDU) session, a specific data radio bearer (DRB), or a specific logical channel (LCH).

Example 36 comprises the subject matter of any variation of examples 33-36, wherein the triggering event comprises receiving a packet with an urgent or critical indication.

Example 37 comprises the subject matter of any variation of example 33, wherein the processor further causes the UE to: adaptively determine an amount of CG occasions needed for transmitting the data, wherein the CG resource is considered active for the determined amount of CG occasions.

Example 38 comprises the subject matter of any variation of examples 33-36, wherein the processor further causes the UE to: send an assistance information message indicating information on minimum and maximum UL/DL preparation times or payload sizes, and wherein the cross-link resource pre-configuration is based on the assistance information message.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given or particular application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context may indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A baseband processor configured to, when executing instructions stored in a memory, perform operations comprising:
receiving a cross-link resource pre-configuration from a base station to pre-configure an action related to a cross-link resource allocation in response to a triggering event related to a data transmission or reception in a first direction;
detecting the triggering event; and
triggering the action related to the cross-link resource allocation to facilitate a reception or a transmission of data in a second direction using the cross-link resource.

2. The baseband processor of claim 1, wherein the first direction is an uplink (UL) direction and the second direction is a downlink (DL) or sidelink (SL) direction, or the first direction is a DL direction and the second direction is a UL or SL direction.

3-5. (canceled)

6. The baseband processor of claim 1, wherein the action comprises considering a downlink (DL) semi persistent scheduling (SPS) configuration associated with a DL SPS resource as modified.

7. (canceled)

8. The baseband processor of claim 1, wherein the action comprises one or more of:
activating a sidelink (SL) resource;
entering or staying in a physical downlink control channel (PDCCH) monitoring mode until a physical downlink shared channel (PDSCH) allocation is received;
considering an uplink (UL) configured grant (CG) resource as activated; or considering an UL CG configuration associated with a UL CG resource as modified.

9-12. (canceled)

13. An apparatus for a base station, comprising:
radio frequency (RF) circuitry;
a memory; and
a processor coupled to the memory and configured to executed instructions stored in the memory to cause the base station to:
detect a triggering event related to an uplink (UL) data transmission from a User Equipment (UE);
in response to the triggering event, trigger an action related to an allocation of a downlink (DL) resource for transmission of DL data; and
transmit, via the RF circuitry, the DL data to the UE using the allocated DL resource.

14. The apparatus of claim 13, wherein the triggering event includes receiving a medium access control (MAC) protocol data unit (PDU) comprising at least one MAC service data unit (SDU) from one of: a specific quality of service (QoS) flow, a specific PDU session, a specific data radio bearer (DRB), a specific logical channel (LCH), or a specific PDU session identity (ID).

15. The apparatus of claim 13, wherein the triggering event includes receiving a scheduling request (SR) associated with a specific logical channel (LCH) or a buffer status report (BSR) associated with the specific LCH.

16. The apparatus of claim 13, wherein the action includes activating a semi persistent scheduling (SPS) resource, modifying the SPS resource, or allocating the DL resource via downlink control information (DCI).

17. The apparatus of claim 13, wherein the processor is further configured to cause the base station to:
receive assistance information from the UE or a core network (CN), wherein the assistance information assists the allocation of the DL resource.

18. The apparatus of claim 17, wherein the assistance information comprises one or more of: a minimum DL payload, a maximum DL payload, a minimum DL preparation time, and a maximum DL preparation time.

19. The apparatus of claim 17, wherein the processor is further configured to cause the base station to:
send a cross-link resource triggering pre-configuration to the UE to pre-configure a UE action related to the allocation of the DL resource in response to a triggering event at the UE, wherein the cross-link resource triggering pre-configuration is based on the assistance information.

20. A method for a User Equipment (UE), comprising:
receiving a cross-link resource triggering pre-configuration from a base station to pre-configure an action related to an allocation of a downlink (DL) or sidelink (SL) resource in response to a triggering event related to an uplink (UL) data transmission;
detecting the triggering event; and
triggering the action to facilitate reception of data using the DL or SL resource.

21. The method of claim 20, wherein the action comprises considering a DL semi persistent scheduling (SPS) resource as activated.

22. The method of claim 21, further comprising:
monitoring the DL SPS resource for an adaptively determined number of SPS occasions, wherein the adaptive determination is based on a logical channel (LCH) associated with the triggering event.

23. The method of claim 21, wherein the DL SPS resource is considered as activated after a waiting duration, wherein the waiting duration begins after transmitting the data, and wherein the waiting duration is configured by the cross-link resource pre-configuration.

24-25. (canceled)

26. The method of claim 20, wherein the action comprises entering a physical downlink control channel (PDCCH) monitoring mode, and wherein the method further comprises:
staying in the PDCCH monitoring mode for a monitoring duration, wherein the monitoring duration is configured by the cross-link resource pre-configuration.

27. The method of claim 20, wherein the action comprises entering a physical downlink control channel (PDCCH) monitoring mode, and wherein the method further comprises:
staying in the PDCCH monitoring mode for a monitoring duration, wherein the monitoring duration is adaptively determined based on a logical channel (LCH) associated with the triggering event.

28. The method of claim 20, wherein the action comprises entering a physical downlink control channel (PDCCH) monitoring mode, and wherein the method further comprises:
entering or staying in the PDCCH monitoring mode after a waiting duration, wherein the waiting duration begins after transmitting or receiving the data, and wherein the waiting duration is configured by the cross-link resource pre-configuration.

29. The method of claim 20, further comprising:
after detecting the triggering event, transmitting a notification message indicating that the triggering event was detected.

30. The method of claim 29, wherein the notification message is transmitted on a same channel as the UL data transmission.

31-38. (canceled)
